(19) United States
(12) Patent Application Publication
(10) Pub. No.: US 2026/0065060 A1
(43) Pub. Date: Mar. 5, 2026

(54) FALSE POSITIVE SENSITIVE TRAINING OF NEURAL NETWORKS FOR MALICIOUS PROMPT CLASSIFICATION

(71) Applicant: Palo Alto Networks, Inc., Santa Clara, CA (US)

(72) Inventors: Brody James Kutt, Santa Clara, CA (US); Samarth Keshari, San Jose, CA (US); Yazdan Jamshidikhezeli, Sunnyvale, CA (US); Sergey Sviridov, Santa Clara, CA (US)

(21) Appl. No.: 18/821,447

(22) Filed: Aug. 30, 2024

(51) Int. Cl. G06N 3/084; G06N 3/045; G06N 3/0464; G06N 3/0475

(52) U.S. Cl. CPC G06N 3/084; G06N 3/045; G06N 3/0464; G06N 3/0475

(57) ABSTRACT

A double cross-entropy loss function is a modification of the standard cross-entropy loss function that is tunable to penalize specific error types, i.e., false positives and false positives for binary classification. A prompt classifier is trained using the double cross-entropy loss function to classify prompts as malicious or benign. The double cross-entropy loss function for the prompt classifier is tuned so that false positive classifications are heavily penalized. The resulting trained prompt classifier maintains a high true positive rate while having a classification threshold that keeps the false positive rate very small. The trained prompt classifier is deployed in a high-load environment for prompt classification.

### BACKGROUND

The disclosure generally relates to data processing (e.g., CPC subclass G06F) and to computing arrangements based on specific computational models (e.g., CPC subclass G06N).

Cross-entropy loss is evaluated using a loss function that measures the discrepancy between two probability distributions. The cross-entropy loss function is used as a loss function for neural networks, where a first of the probability distributions is the “ground-truth” distribution comprising a one-hot vector with a one in an entry corresponding to the known class of an input to the neural network and zeroes elsewhere, and a second of the probability distributions is a vector of confidence values output by a neural network representing predicted probabilities that the input belongs to various classes. During training of a neural network, the gradients of the cross-entropy loss function with respect to learnable parameters are evaluated for batches of inputs, and the resulting values for a batch are used to backpropagate a learning signal through internal layers of the neural network. Training using backpropagation with a loss function can be applied to ensembles of neural networks provided that the ensemble of neural networks is itself a neural network.

Receiver operating characteristic (ROC) curves represent the performance of binary classifiers. ROC curves are plots of true positive rate (TPR) against false positive rate (FPR) for varying classification decision thresholds. Each classification threshold is a threshold that determines verdicts based on outputs by the binary classifier, i.e., an output by the binary classifier above the threshold has a positive classification and an output by the binary classifier below the threshold has a negative classification. A typical quality metric for a binary classifier is the area under the ROC curve.

### BRIEF DESCRIPTION OF THE DRAWINGS

Embodiments of the disclosure may be better understood by referencing the accompanying drawings.

FIG. 1 is a schematic diagram of an example system for training a large prompt classifier using double cross-entropy loss and training a lightweight prompt classifier using double cross-entropy loss and knowledge distillation loss.

FIG. 2 is an illustrative diagram of an example ROC curve for a binary classifier having a high area under curve metric and a binary classifier having high TPR at a low threshold FPR.

FIG. 3 is a flowchart of example operations for training a large prompt classifier to classify prompts with double cross-entropy loss.

FIG. 4 is a flowchart of example operations for training a lightweight prompt classifier to classify prompts using KD loss with a trained large prompt classifier and double cross-entropy loss.

FIG. 5 is a flowchart for deploying a trained prompt classifier for malicious prompt detection.

FIG. 6 depicts an example computer system with a classifier trainer, a large prompt classifier, and a lightweight prompt classifier.

### DESCRIPTION

The description that follows includes example systems, methods, techniques, and program flows to aid in understanding the disclosure and not to limit claim scope. Well-known instruction instances, protocols, structures, and techniques have not been shown in detail for conciseness.

### INTRODUCTION

For many applications where there is a high volume of samples to classify and a high rate of false positive classifications by a binary classifier is unacceptable, area under the ROC curve may not be the ideal metric to evaluate the performance of the binary classifier. To exemplify, when the binary classifier is a classifier of malicious prompts to a generative artificial intelligence (AI) system, the only practical way to handle the volume of positive malicious prompt classifications is to keep the FPR below a threshold (e.g., 0.1%). The typical way of imposing that the FPR is very low is to set a classification threshold very close to 1, so that only malicious prompts with very high confidence values of being malicious receive malicious verdicts. However, even for classifiers with a high area under the ROC curve, choosing a high classification threshold may nonetheless result in a low TPR, resulting in many missed malicious verdicts. A better metric for performance for this scenario than the area under the ROC curve is the TPR of the binary classifier for various fixed, small FPR thresholds (e.g., 0.1%, 0.01%, 0.005%) that are acceptable FPRs for a deployment environment.

### Overview

The present disclosure proposes both a training methodology for training classifiers that achieve high TPRs at low FPR thresholds and an effective neural network architecture for receiving dynamically sized prompt inputs when rendering verdicts. The training methodology comprises a “double cross-entropy loss function” that is the sum of the standard cross-entropy loss function and a loss function that penalizes misclassifications of inputs having class i into class j. The choices of the classes i and j to penalize and the penalization weights are tunable parameter values in the double cross-entropy loss function. For the case of malicious or benign prompt classification, penalizing misclassifying a benign prompt as malicious (i.e., a false positive classification) promotes high TPR at low FPR thresholds.

A large prompt classifier is trained on known malicious or benign prompts with the double cross-entropy loss function having parameter values that heavily penalize misclassifying benign prompts as malicious. The large prompt classifier comprises input layers that are capable of receiving dynamically sized inputs, tokenization layers and vector embedding layers that perform natural language processing (NLP), dynamic compression layers that compress the dynamically sized inputs into fixed length inputs, and a large classification model that takes the fixed length inputs and outputs the malicious or benign probability predictions. Once trained, the large prompt classifier is used to train a lightweight prompt classifier using knowledge distillation (KD) loss. The lightweight prompt classifier comprises equivalent architecture to the large prompt classifier with the exception that the large classification model is replaced with a lightweight classification model. To enrich training of the lightweight prompt classifier, a distillation loss function is added to the double cross-entropy loss function during training. The distillation loss function compares outputs of the large prompt classifier to outputs of the lightweight prompt classifier and imposes a penalty when these outputs are different. Once trained, the lightweight and large prompt classifiers are both able to classify malicious or benign prompts at low threshold FPRs while maintaining high TPRs. Moreover, the lightweight prompt classifier is able to generate accurate, low FPR verdicts in a deployment environment that experiences high volumes of prompts.

### Terminology

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

The term “confidence values” as used herein refers to likelihood values output by a classifier that indicate the likelihood that an input belongs to classes corresponding to each confidence value. Confidence values can alternatively be referred to as “probabilities” or “scores”.

The term “error type” refers to a type of misclassification by a classifier wherein the classifier misclassifies an input as a specific class that is distinct from a ground-truth class of the input. Each error type corresponds both to the incorrect class that the input was classified as and the ground truth class of the input. For a binary classifier, the two error types are commonly referred to as false positives (misclassifying a negative input as a positive input) and false negatives (misclassifying a positive input as a negative input).

### Example Illustrations

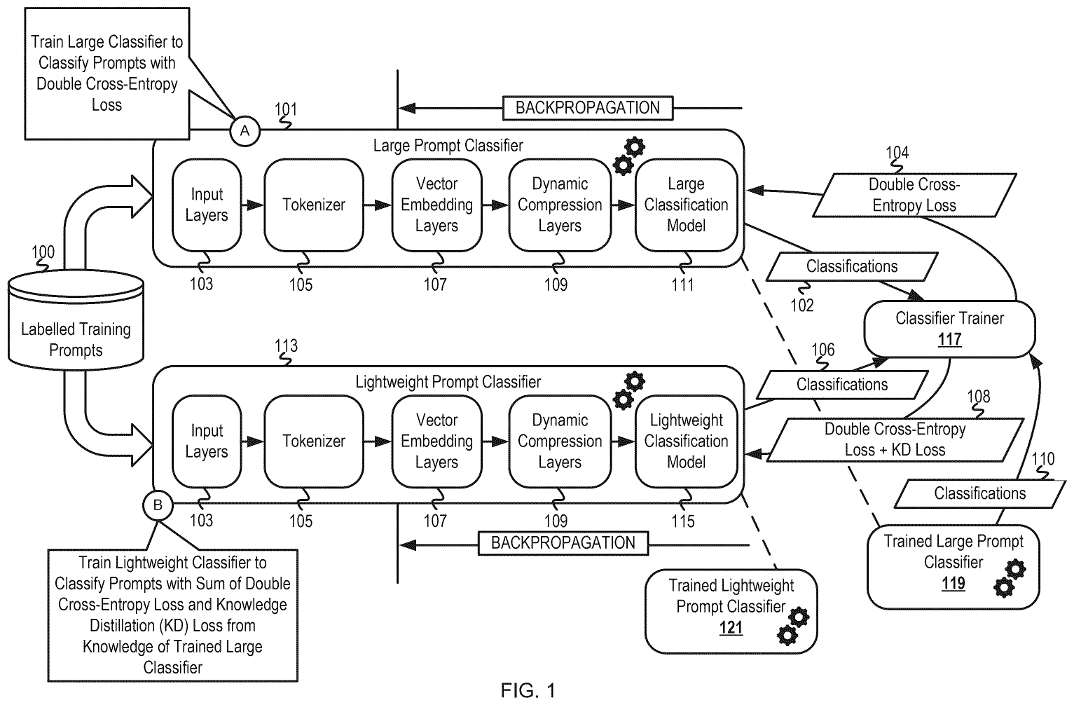

FIG. 1 is a schematic diagram of an example system for training a large prompt classifier using double cross-entropy loss and training a lightweight prompt classifier using double cross-entropy loss and KD loss. A classifier trainer 117 trains a large prompt classifier 101 and a lightweight prompt classifier 113 using labeled training prompts 100 to classify prompts as malicious or benign. The classifier trainer 117 first trains the large prompt classifier 101 with double cross-entropy loss 104 to obtain trained large prompt classifier 119. Then, the classifier trainer 117 trains the lightweight prompt classifier 113 with double cross-entropy loss+KD loss 108, using double cross-entropy loss on the output of the lightweight prompt classifier 113 and KD loss on the outputs of both the lightweight prompt classifier 113 and the trained large prompt classifier 119, to obtain trained lightweight prompt classifier 121.

FIG. 1 is annotated with a series of letters A and B. Each stage represents one or more operations. Although these stages are ordered for this example, the stages illustrate one example to aid in understanding this disclosure and should not be used to limit the claims. Subject matter falling within the scope of the claims can vary from what is illustrated.

At stage A, the classifier trainer 117 trains the large prompt classifier 101 to classify prompts using labeled training prompts 100 by backpropagating double cross-entropy loss 104 on its classifications 102 output at each training iteration. The classifications 102 comprise vectors [p₀, p₁] of confidence values between 0 and 1 that each labeled training prompt is malicious and benign, respectively, with p₀=1−p₁ (alternatively, the classifications 102 can comprise p₀ for each training prompt and p₁ can be inferred using this formula). For each training iteration, the classifier trainer 117 computes double cross-entropy loss 104 using the classifications 102 and ground-truth labels for those of the labeled training prompts 100 used for training at that iteration and backpropagates the loss 104 through the large prompt classifier 101.

For clarity, the double cross-entropy loss function for the double cross-entropy loss 104 is first described below for k classes and then simplified to the case k=2 for malicious/benign prompt classification in the example in FIG. 1. In the following formula, x is the input to a neural network, c={0, 1, . . . , k−1} are the class labels for the k classes, y∈R^{k} is a one-hot label vector with a one entry for the ground-truth label of the input and zeroes elsewhere, p∈R^{k} is a vector of confidence values (i.e., a score vector) that sums to 1, with each entry indicating the likelihood that the input belongs to a corresponding one of the k classes as predicted by the neural network, z∈R^{k} is a one-hot vector with a one entry at index argmax(p) and zeroes elsewhere (i.e., a vector that indicates which class the confidence values predict), and C∈R^{k×k} is a cost matrix with entries {c_{i,j}}_{i,j∈c}, wherein the entries c_{i,j} represent the scaling factor for the cost by the loss function for misclassifying an input with ground-truth class i into class j. The diagonal entries c_{i,i} are zero so that classifying an input into its ground-truth class is not penalized. The double cross-entropy loss function is computed by the formula:

$$ℒ ( x , y ) = - {\sum }_{i ∈ c} {y}_{i} log ( {p}_{i} ) - {\sum }_{i ∈ c} {c}_{argmax ( y ) , i} {z}_{i} log ( 1 - {p}_{i} )$$

The first term in the above double-cross entropy loss function is the standard cross-entropy loss function. The second term is a term that, for each pair of classes (i,j), penalizes misclassifying x into class j instead of ground-truth class i. The cost matrix Cis tunable—if a particular error type for misclassification is undesirable, the corresponding value of the cost matrix can be increased. This is the improvement of the double cross-entropy loss function over existing cross-entropy based loss functions which do not account for error types. For the case of binary classification, the double cross-entropy loss function can target false positives (misclassifying a benign sample as malicious) and false negatives (misclassifying a malicious sample as benign).

A variant of the double cross-entropy loss function is the following formula:

$$ℒ ( x , y ) = - {\sum }_{i ∈ c} {y}_{i} log ( {p}_{i} ) - {\sum }_{i ∈ c} {c}_{argmax ( y ) , i} {z}_{i} log ( 1 - {p}_{i} )$$

Rather than only penalizing misclassification according to the largest confidence value, this variant also penalizes other confidence values than the largest confidence value. This is because pᵢ (that has values for every class) is used as coefficients in the second term as opposed to zᵢ (that has one value for the ground-truth class and zeroes otherwise) in the previous formula.

Reducing the first double cross-entropy loss function presented above to the case k=2, for an input prompt x, a one hot label vector y=[y₀, y₁], and a classification [p₀, p₁], the double cross-entropy loss function is computed as:

$$ℒ ( x , y ) = - {y}_{0} log ( {p}_{0} ) - {y}_{1} log ( {p}_{1} ) - {c}_{argmax ( y ) , 0} {z}_{0} log ( 1 - {p}_{0} ) - {c}_{argmax ( y ) , 1} {z}_{1} log ( 1 - {p}_{1} )$$

C is set to c_{0,1}=1, the increased cost for misclassifying the 0^{th} class (malicious) as the 1^{st} class (benign), i.e., false negative classifications, and c_{1,0}=w for a tunable weight w>1, the increased cost of misclassifying the 1^{st} class (benign) as the 0^{th} class (malicious), i.e., false positive classifications (c_{0,0} and c_{1,1} are both zero). For clarity regarding the third and fourth terms and how they penalize error types, the four possible cases—correct malicious classification, correct benign classification, false positive classification, and false negative classification are described herewith.

For a correct malicious classification, z=(1, 0) and y=(1, 0). The third term is zero because c_{argmax(y),0}=c_{0,0}=0 and the fourth term is zero because z₁=0.

For a correct benign classification, z=(0, 1) and y=(0, 1). The third term is zero because z₀=0 and the fourth term is zero because c_{argmax(y),1}=c_{1,1}=0.

For a false positive classification, z=(1, 0) and y=(0, 1). In the third term, c_{argmax(y),0}z₀=c_{1,0}=w. The fourth term is zero because z₁=0. Thus, the third term is scaled by the factor w>1 for false positive classifications.

For a false negative classification, z=(0,1) and y=(1,0). The third term is zero because z₀=0. In the fourth term, c_{argmax(y),1} z₁=c_{0,1}=1. Thus, the fourth term is scaled by the factor 1 for false negative classifications.

This illustrates how the loss function penalizes error types for misclassifications according to the chosen cost values, and by tuning w (e.g., w=2, 5, 10, 20), the double cross-entropy loss function reinforces low false positives.

At each training iteration, the classifier trainer 117 computes the double cross-entropy loss 104 as the sum of the double cross-entropy losses for each prompt at that training iteration computed according to either of the above formulae (the original or the variant) using the classifications 102. The classifier trainer 117 then backpropagates the loss through the large prompt classifier 101 using the gradient of this computed loss. The classifier trainer 117 continues training iterations (i.e., training batches/epochs) until training criteria are satisfied. The training criteria can comprise that training/testing/validation loss is sufficiently low, that a threshold number of training iterations has occurred, that internal parameters of the large prompt classifier 101 are converging across training iterations, etc. Prompts in the labeled training prompts 100 can be separated into training/testing/validation prompts for this purpose.

The large prompt classifier 101 comprises a composition of input layers 103, a tokenizer 105, vector embedding layers 107, dynamic compression layers 109, and a large classification model 111. The input layers 103 accept variably sized inputs (i.e., variably sized prompts) and can have a maximum input size above which inputs are truncated and input to the large prompt classifier 101 separately. The input layer 103 can additionally perform cleaning operations such as removing nonce characters sequences, removing American Code for Information Interchange (ASCII) characters outside of certain ranges (e.g., non-alphanumeric and non-punctuation characters), etc.

The tokenizer 105 identifies and extracts tokens from outputs of the input layers 103. For instance, the tokenizer 105 can have a list of punctuation ASCII characters such as “ ”, “.”, “,”, “;”, “?”, etc. and can extract tokens as character sequences delimited by ASCII characters in the list (with the punctuation characters removed). In some embodiments, the tokenizer 105 can use regular expressions to identify tokens. The tokenizer 105 also has access to a vocabulary of tokens and corresponding token indices. The indices are used to look up vector embeddings for each token in the vector embedding layers 107. The tokenizer 105 maps each extracted token to its corresponding index and stores the extracted tokens as a sequence of indices.

The vector embedding layers 107 receive the sequence of indices from the tokenizer 105 and perform a lookup to obtain a vector embedding (i.e., a numerical vector) for each extracted token. Each vector embedding comprises learnable weights, with semantically similar tokens having close vector embeddings and semantically dissimilar tokens having distant vector embeddings. For instance, the vector embedding layers 107 can be implemented with an off-the-shelf tool such as word2vec.

The dynamic compression layers 109 comprise layers that compress the variable length outputs of the vector embedding layers 107 into a fixed-length output while preserving information in the vector embeddings. As an example, the dynamic compression layers can comprise pooling layers with a window size w and stride length s chosen according to the following algorithm, where X is the input to the vector embedding layers 107, Z is the output of the vector embedding layers 107, and a is a target fixed length for outputs.

Algorithm 2 Optimal Adaptive Pooling Algorithm

```
Given X ∈ [symbol] , a
Output Z ∈ [symbol]
if h ≤ a then
  s, w = (1, 1)
else
  $candidate 1 = ( ⌊ \frac{h}{a} ⌋ , ⌈ h - ( a - 1 ) ⌊ \frac{h}{a} ⌋ ⌉ )$
  $if ⌈ \frac{h}{a} ⌉ < \frac{h}{a - 1} then$
    $candidate 2 = ( ⌈ \frac{h}{a} ⌉ , ⌈ \frac{h}{a} ⌉ )$
    s, w = argmin_{w} (candidatel, candidate 2) (tie broken by smaller s)
  else
    s, w = candidate 1
  end if
end if
p = w + (a − 1) s − h
if p > 0 then
  append X with padding vector of size p × e
end if
for each submatrix {Mᵢ}ᵢ of X of size w × e spaced according to stride
length s do
  average current submatrix Mᵢ along first dimension to generate \tilde{M}ᵢ
end for
Z = stacked {\tilde{M}ᵢ}ᵢ
Return Z
```

More generally, the dynamic compression layers 109 can implement any differentiable compression algorithm that preserves information in the vector embeddings. For instance, the dynamic compression layers 109 can use dimensionality reduction algorithms (e.g., autoencoder neural networks) to reduce the dimension of the vector embeddings to a fixed length. The above algorithm for dynamic compression is presented because it results in fixed-length outputs and preserves salient content in the vector embeddings as they are compressed, where saliency is determined as that which results in separability of the classes for computing low classification loss.

The large classification model 111 comprises a transformer neural network (e.g., Bidirectional Encoding Representations from Transformers (BERT) or related models such as Decoding-enhanced BERT with disentangled attention) with many (e.g., billions) of internal parameters. Moreover, the large classification model 111 can be trained on a large variety of training data for various language tasks outside of the context of malicious or benign prompts to generative AI systems. This additional training enriches predictions by the large classification model 111 once it is fine-tuned to the task of classifying prompts according to the training operations depicted in FIG. 1.

Because the vector embedding layers 107 and the dynamic compression layers 109 are differentiable and the large classification model 111 is a neural network, loss is backpropagated through these modules 107, 109, 111 in an end-to-end fashion during training. The modules 107, 109, and 111 form an ensemble of neural networks, and therefore the loss can be backpropagated. This means that, as the large prompt classifier 101 is trained by the classifier trainer 117, the vector embedding layers 107 learn vector embeddings that are effective for malicious prompt classification.

At stage B, the classifier trainer 117 trains the lightweight prompt classifier 113 to classify prompts using labeled training prompts 100 by backpropagating the gradient of double cross-entropy loss+KD loss 108 on its classifications 106 and classifications 110 output by the trained large prompt classifier 119 at each training iteration. The double-cross entropy loss in the loss 108 is computed using the double cross-entropy loss function on the classifications 106 as described in the foregoing.

The KD loss in the loss 108 is calculated as a temperature-scaled Kullback-Leibler (KL) divergence of the classifications 106 from the classifications 110. The KL divergence measures the distance between probability distributions. Each of the classifications 106, 110 is a probability distribution because they are vectors of confidence values that sum to 1, so the KD loss penalizes when classifications by the lightweight prompt classifier 113 vary from classifications by the trained large prompt classifier 119. The classifications 110 output by the trained large prompt classifier 119 is the reference distribution when computing the KL divergence for the KD loss. The “temperature” is a parameter used in a softmax function for logits of the classifications 106, 110 when computing KD loss, where a higher temperature parameter increases entropy of the classifications 106, 110 and therefore provides more information when computing the KD loss. When computing the loss 108, rather than taking the sum, balancing or weighting parameters can be applied that weigh the double cross-entropy loss and the KD loss relative to one another. The classifier trainer 117 trains the lightweight prompt classifier 113 across training iterations using backpropagation with the gradient of loss 108 as similarly described in the foregoing for the large prompt classifier 101, where loss is backpropagated through the ensemble of the modules 107, 109, and 115.

The KD loss doesn't penalize using ground-truth labels from the labeled training prompts 100. This is because sometimes a confidence value output by the trained large prompt classifier 119 carries more/different information than a label. To exemplify, if a confidence value is closer to 0.5 than to 0 or 1, that means a corresponding prompt does not appear definitively malicious or benign. This carries additional information than a label that simply indicates whether a prompt is malicious or benign. Training the lightweight prompt classifier 113 with the additional KD loss incorporates the contextual learnings of the trained large prompt classifier 119 from its pre-training across language tasks into the training of the lightweight prompt classifier 113.

The lightweight prompt classifier 113 comprises a composition of the input layer 103, the tokenizer 105, the vector embedding layers 107, and the dynamic compression layers 109 having the same architecture as these layers in the large prompt classifier 101. However, during/after training the weights within these layers will vary between the lightweight prompt classifier 113 and the large prompt classifier 101. The instantiations of the input layers 103, the tokenizer 105, the vector embedding layers 107, and the dynamic compression layers 109 in the large prompt classifier 101, although they have the same architecture, comprise distinct layers than the counterpart layers in the lightweight prompt classifier 113 and are initialized independently prior to training. In other embodiments, layers trained during training of the large prompt classifier 101 can be inserted into the lightweight prompt classifier 113 and can be further trained thereafter.

Instead of the large classification model 111, the lightweight prompt classifier 113 comprises a lightweight classification model 115 receiving outputs of the dynamic compression layers 109 as inputs. The lightweight classification model 115 comprises a model with a small amount (e.g., thousands) of parameters that is configured to be deployed in an environment receiving a high volume (e.g., millions per day) of prompts to classify. For instance, the lightweight classification model 115 can comprise a lightweight convolutional neural network (CNN) or other type of neural network classifier with few parameters. As for the large prompt classifier 101, during training the loss 108 is backpropagated through the lightweight classification model 115, the dynamic compression layers 109, and the vector embedding layers 107. Once trained, the classifier trainer 117 deploys the lightweight prompt classifier 113 for prompt classification as trained lightweight prompt classifier 121.

The architecture of the large prompt classifier 101 and the lightweight prompt classifier 113 can vary by implementation. Any classifier/machine learning model architecture having an NLP model for preprocessing inputs and a subsequent neural network/language model for which loss can be backpropagated can be implemented. For different implementations, backpropagation may only be possible for smaller or different parts of the architecture.

The following table illustrates performance improvements of double cross-entropy loss (double XE) over other types of cross-entropy loss including standard cross-entropy loss (XE), weighted cross-entropy loss (weighted XE) with loss function

$$ℒ ( x , y ) = - {w}_{argmax ( y )} {\sum }_{i ∈ c} {y}_{i} log ( {p}_{i} ) ,$$

where classes have weights wᵢ in the standard cross-entropy loss, focal loss (focal) with loss function

$$ℒ ( x , y ) = - {w}_{argmax ( y )} {\sum }_{i ∈ c} {{y}_{i} ( 1 - {p}_{i} )}^{γ} log ( {p}_{i} ) ,$$

for some parameter γ>0, and weighted double cross-entropy loss (weighted double XE) with loss function

$$ℒ ( x , y ) = - {w}_{argmax ( y )} {\sum }_{i ∈ c} {y}_{i} log ( {p}_{i} ) - {\sum }_{i ∈ c} {c}_{argmax ( y ) , i} {p}_{i} log ( 1 - {p}_{i} ) .$$

Focal loss also has a class balancing factor α∈[0,1] that deals with class imbalance, with positive and negative classes having weighting factors α and 1−α, respectively, when computing focal loss.

The “v2” versions of double cross-entropy loss and weighted double cross-entropy loss in the formula use the variant formula for double cross-entropy loss presented above (i.e. by replacing the second term with the second term in the second formula for double cross-entropy loss above). The table displays the TPR of the lightweight prompt classifier at fixed FPR thresholds (0.1%, 0.01%, and 0.005%) over a testing dataset and a validation dataset.

| | Val Set | Test Set | | |
|---|---|---|---|---|
| | FPR | FPR | FPR | FPR |
| Loss Type | @ 0.1% | @ 0.1% | @ 0.01% | @ 0.005% |
| XE | 95.71% | 98.71% | 95.32% | 93.45% |
| Weighted XE 1 | 94.70% | 98.61% | 95.57% | 94.59% |
| Weighted XE 2 | 95.76% | 98.72% | 97.00% | 93.29% |
| Weighted XE 3 | 94.35% | 98.54% | 95.78% | 93.75% |
| Weighted XE 4 | 94.27% | 98.66% | 93.09% | 90.74% |
| Double XE 1 | 96.12% | 98.87% | 96.80% | 95.39% |
| Double XE 2 | 96.67% | 98.96% | 97.95% | 97.46% |
| Focal 1 | 95.48% | 98.91% | 96.00% | 94.84% |
| Focal 2 | 94.72% | 98.31% | 91.16% | 88.52% |
| Focal 3 | 95.96% | 98.84% | 95.88% | 93.87% |
| Focal 4 | 95.70% | 98.88% | 97.08% | 96.85% |
| Focal 5 | 96.05% | 98.71% | 97.59% | 97.25% |
| Weighted Double XE | 95.30% | 98.92% | 97.83% | 97.39% |
| Double XE v2 | 96.49% | 98.92% | 97.26% | 96.04% |
| Weighted Double XE v2 | 97.05% | 98.62% | 96.09% | 94.84% |

In the above table, weighted XE 1 has benign weight 2.0 and malicious weight 1.0, weighted XE 2 has benign weight 1.0 and malicious weight 2.0, weighted XE 3 has benign weight 10 and malicious weight 1.0, weighted XE 4 has benign weight 1.0 and malicious weight 10.0, double XE 1 has false positive cost 2.0 and false negative cost 1.0, double XE 2 has false positive cost 2.0 and false negative cost 1.0, focal 1-5 have γ=2, with α=0.5, 0.25, 0.75, 0.1, and 0.9, respectively, weighed double XE has false positive cost 10.0, false negative cost 1.0, benign weight 10.0, and malicious weight 1.0, double XE v2 has false positive cost 10.0 and false negative cost 1.0, and weighted double XE v2 has false positive cost 10.0, false negative cost 1.0, benign weight 10.0, and malicious weight 1.0. For every FPR threshold for the testing and validation datasets, a version of either double cross-entropy loss or weighted double cross-entropy loss achieves both of the top-2 TPRs.

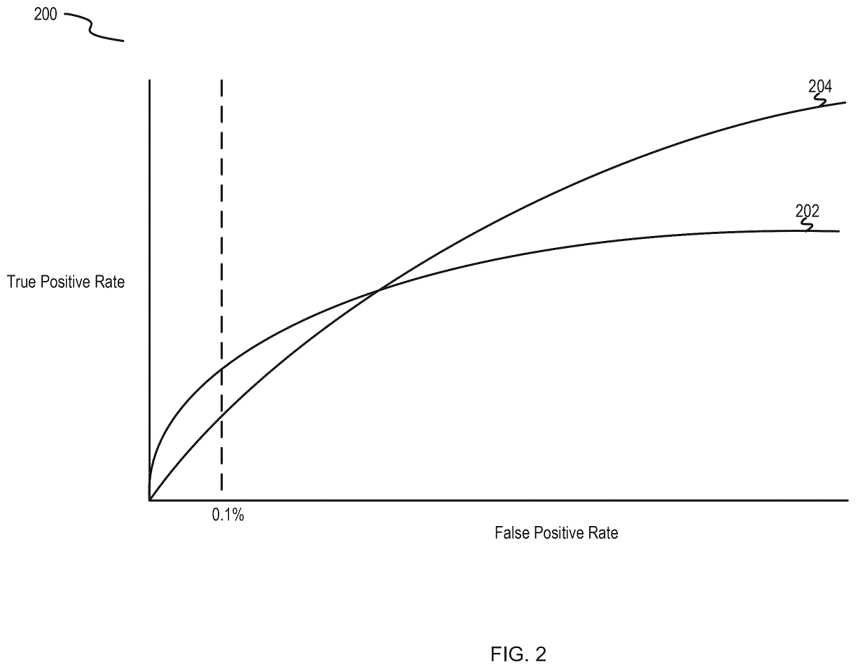

FIG. 2 is an illustrative diagram of an example ROC curve for a binary classifier having a high area under curve metric and a binary classifier having high TPR at a low threshold FPR. A graph 200 plots TPR on the vertical axis and FPR on the horizontal axis for varying classification thresholds of binary classifiers (although the graph 200 is depicted as a continuous curve, in practice this graph would be discrete with values at every classification threshold that is evaluated). A first binary classifier has ROC curve 204 and a second binary classifier has ROC curve 202. Although the first binary classifier has a greater area under the ROC curve 204 than the second binary classifier, the second binary classifier performs at a better TPR for the FPR threshold 0.1%. Training the second binary classifier using double cross-entropy loss promotes this performance. This is useful for implementations where a low or ultra-low FPR is required for a classifier to be deployed.

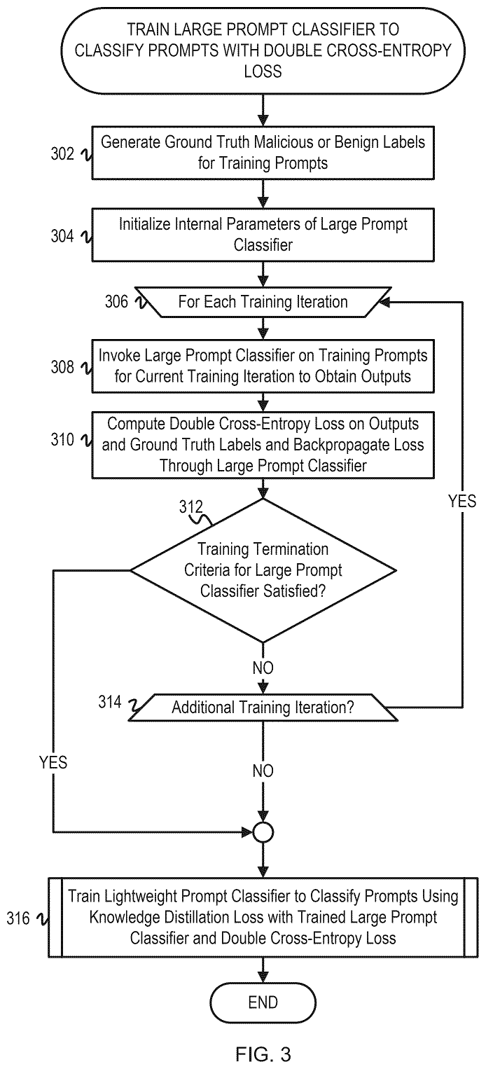

FIGS. 3-5 are flowcharts of example operations for training and deploying prompt classifiers for malicious prompt detection using double cross-entropy and knowledge distillation loss. The example operations are described with reference to a large prompt classifier, a lightweight prompt classifier, and a classifier trainer for consistency with the earlier figures and/or ease of understanding. The name chosen for the program code is not to be limiting on the claims. The structure and organization of a program can vary due to platform, programmer/architect preferences, programming language, etc. In addition, the names of code units (programs, modules, methods, functions, etc.) can vary for the same reasons and can be arbitrary.

FIG. 3 is a flowchart of example operations for training a large prompt classifier to classify prompts with double cross-entropy loss. At block 302, a classifier trainer generates ground truth malicious or benign labels for training prompts. The training prompts can be prompts encountered by generative AI systems. The malicious labels can be generated based on known malicious attacks on the generative AI systems, and prompts not otherwise known to be malicious can be labeled as benign. Although the training prompts are described as having “ground-truth” labels, in practice the labels can often be noisy with potentially incorrect labels. The classifier trainer can split the training prompts into training/testing/validation prompts for later evaluations of training/testing/validation loss.

At block 304, the classifier trainer initializes the internal parameters of a large prompt classifier. The large prompt classifier has a large number (e.g., billions) of internal parameters. The large prompt classifier comprises a composition of an NLP model that preprocesses input and subsequent neural network layers that output confidence values that prompts are malicious or benign. For instance, the large prompt classifier can comprise a composition of input layers, a tokenizer, vector embedding layers, dynamic compression layers, and a large classification model (e.g., a large transformer neural network). Any of these components can be off-the-shelf tools or models. Initialization of internal parameters can be random and can depend on the type of internal layers of the large prompt classifier and, in some embodiments, can occur when a third-party source provides the various components.

At block 306, the classifier trainer begins iterating through training iterations. Training iterations comprise batches of training prompts across training epochs.

At block 308, the classifier trainer invokes the large prompt classifier on training prompts for the current training iterations to obtain outputs. The outputs comprise confidence values that each training prompt is malicious or benign. The large prompt classifier is configured to accept variably sized training prompts and, in some instances, may split a training prompt into multiple training prompts each having the same label as the original when the training prompt is longer than the maximum input length for the large prompt classifier.

At block 310, the classifier trainer computes the double cross-entropy loss on the outputs as the ground truth labels and backpropagates the loss through the large prompt classifier. The double cross-entropy loss is the sum of losses for the outputs and is evaluated with the double cross-entropy loss function applied to each output and corresponding ground truth label according to the foregoing description.

At block 312, the classifier trainer determines whether the training termination criteria for the large prompt classifier are satisfied. The training criteria can comprise that a threshold number of batches/epochs have occurred, that training/testing/validation loss is sufficiently low, that internal parameters of the large prompt classifier converge across training iterations, some combination thereof, etc. The training criteria can depend on available computing resources for training the large prompt classifier. If the training criteria are satisfied, operational flow proceeds to block 316. Otherwise, operational flow proceeds to block 314.

At block 314, the classifier continues training iterations for the large prompt classifier. If there are additional training iterations (e.g., additional batches/epochs according to maximum batch/epoch values for training), operational flow returns to block 306. Otherwise, operational flow proceeds to block 316.

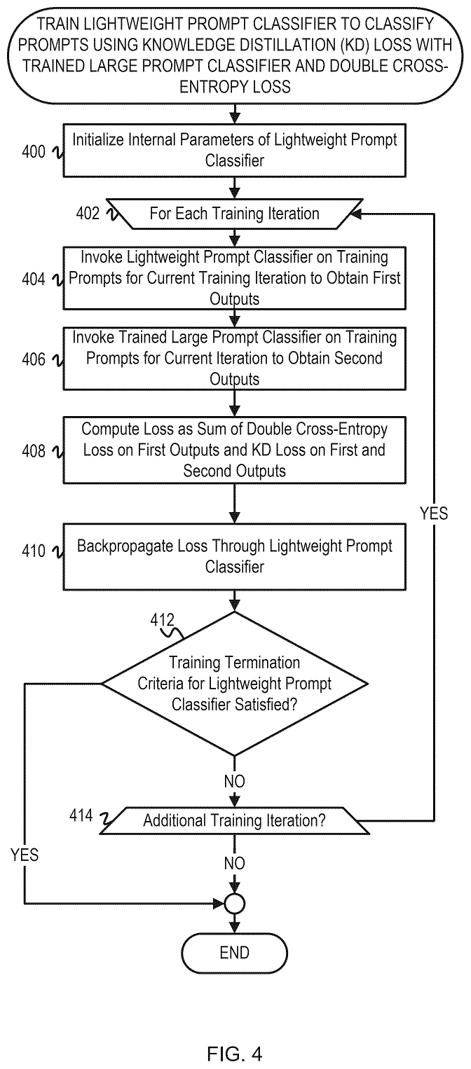

At block 316, the classifier trainer trains the lightweight prompt classifier to classify prompts using KD loss with the trained large prompt classifier and double cross-entropy loss. The operations at block 316 are described in greater detail in reference to FIG. 4.

FIG. 4 is a flowchart of example operations for training a lightweight prompt classifier to classify prompts using KD loss with a trained large prompt classifier and double cross-entropy loss. Many of the operations in FIG. 4 are described in brevity due to similarity to corresponding operations described in reference to FIG. 3. At block 400, a classifier trainer initializes the internal parameters of a lightweight prompt classifier. The lightweight prompt classifier has a low (e.g., thousands) number of parameters. At block 402, the classifier trainer begins iterating through training iterations. At block 404, the classifier trainer invokes the lightweight prompt classifier on training prompts for the current iteration to obtain first outputs. At block 406, the classifier trainer invokes the trained large prompt classifier on training prompts for the current iteration to obtain second outputs. At block 408, the classifier trainer computes the loss for the current iteration as a sum of double cross-entropy loss on the first outputs and KD loss on the first and second outputs. The double cross-entropy loss is computed on the second outputs as described in the foregoing using the double cross-entropy loss function. The KD loss is computed as the KL divergence between outputs in the first outputs and corresponding outputs in the second outputs according to the foregoing description. At block 410, the classifier trainer backpropagates the loss through the lightweight prompt classifier. At block 412, the classifier trainer determines whether the training criteria for the lightweight prompt classifier are satisfied. If the training criteria are satisfied, the operational flow is complete. Otherwise, the operational flow proceeds to block 414. At block 414, the classifier trainer continues training iterations. If there is another training iteration, the operational flow returns to block 402. Otherwise, the operational flow is complete.

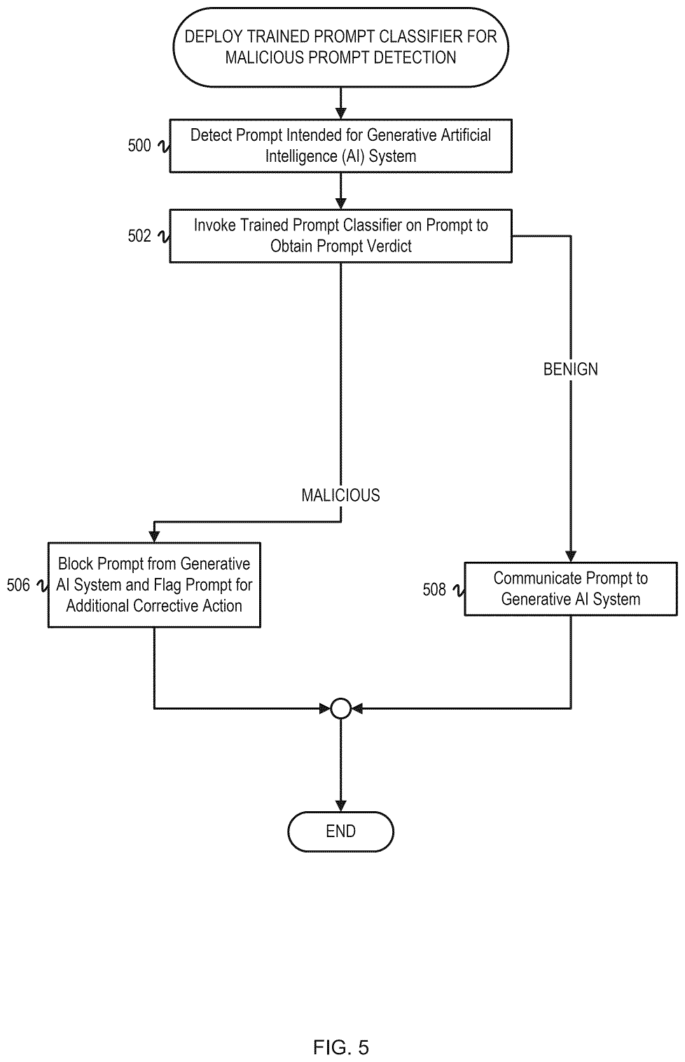

FIG. 5 is a flowchart for deploying a trained prompt classifier for malicious prompt detection. The trained prompt classifier was trained to classify malicious or benign prompts using the double cross-entropy loss and, optionally, KD loss with another trained prompt classifier according to the foregoing description. At block 500, a cybersecurity appliance detects a prompt intended for a generative AI system. The cybersecurity appliance can monitor inputs and outputs to the generative AI system, for instance by monitoring outgoing/incoming packets to/from application programming interface (API) endpoints of the generative AI system. The cybersecurity appliance can monitor network traffic to detect malicious prompts across endpoint devices, e.g., across endpoint devices of an organization.

At block 502, the cybersecurity appliance invokes a trained prompt classifier on the detected prompt to obtain a prompt verdict. If the cybersecurity appliance receives a high volume (e.g., millions per day) of prompts to classify, the trained prompt classifier can comprise a lightweight prompt classifier according to the foregoing descriptions. If the cybersecurity appliance receives a lower volume of prompts to classify, the trained prompt classifier can comprise a large prompt classifier also according to the foregoing description. If the verdict is malicious, operational flow proceeds to block 506. Otherwise, operational flow proceeds to block 508.

At block 506, the cybersecurity appliance blocks the prompt from being communicated to the generative AI system and flags the prompt for additional corrective action. The additional corrective action can comprise blocking an entity (e.g., an endpoint device, Internet Protocol address, etc.) that communicated the prompt, further analyzing the prompt to determine the type of malicious attack, adding the prompt to a training or knowledge database, etc.

At block 508, the cybersecurity appliance communicates the prompt to the generative AI system. The cybersecurity appliance continues to monitor the inputs/outputs of the generative AI system to ensure that the generative AI system is behaving normally.

### Variations

The foregoing description refers to training classifiers with double cross-entropy loss and KD loss to classify prompts as malicious or benign. Alternatively, double cross-entropy loss and KD loss can be used to train classifiers to classify any documents (e.g., JavaScript® code, HyperText Markup Language documents, network packet capture files, etc.) as malicious or benign. Moreover, classifiers can be trained to predict additional or alternative classes, with classifiers that predict additional classes being trained according to either of the multi-class formulae for double cross-entropy loss provided in the foregoing. For example, classifiers can be trained using double cross-entropy loss for named entity recognition in the context of data loss prevention. The classifiers can be trained to predict more than two classes such as driver's license number entities, name entities, phone number entities, address entities, etc. A “composition” of models as used in the foregoing can alternatively be referred to as an “ensemble”.

The flowcharts are provided to aid in understanding the illustrations and are not to be used to limit the scope of the claims. The flowcharts depict example operations that can vary within the scope of the claims. Additional operations may be performed; fewer operations may be performed; the operations may be performed in parallel; and the operations may be performed in a different order. For example, the operations depicted at blocks 408 and 410 can be performed in parallel or concurrently across training prompts/outputs at each training iteration. It will be understood that each block of the flowchart illustrations and/or block diagrams, and combinations of blocks in the flowchart illustrations and/or block diagrams, can be implemented by program code. The program code may be provided to a processor of a general-purpose computer, special-purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine-readable medium(s) may be utilized. The machine-readable medium may be a machine-readable signal medium or a machine-readable storage medium. A machine-readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine-readable storage medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine-readable storage medium may be any tangible medium that can contain, or store a program for use by or in connection with an instruction execution system, apparatus, or device. A machine-readable storage medium is not a machine-readable signal medium.

A machine-readable signal medium may include a propagated data signal with machine-readable program code embodied therein, for example, in baseband or as part of a carrier wave. Such a propagated signal may take any of a variety of forms, including, but not limited to, electro-magnetic, optical, or any suitable combination thereof. A machine-readable signal medium may be any machine-readable medium that is not a machine-readable storage medium and that can communicate, propagate, or transport a program for use by or in connection with an instruction execution system, apparatus, or device.

Program code embodied on a machine-readable medium may be transmitted using any appropriate medium, including but not limited to wireless, wireline, optical fiber cable, RF, etc., or any suitable combination of the foregoing.

The program code/instructions may also be stored in a machine-readable medium that can direct a machine to function in a particular manner, such that the instructions stored in the machine-readable medium produce an article of manufacture including instructions that implement the function/act specified in the flowchart and/or block diagram block or blocks.

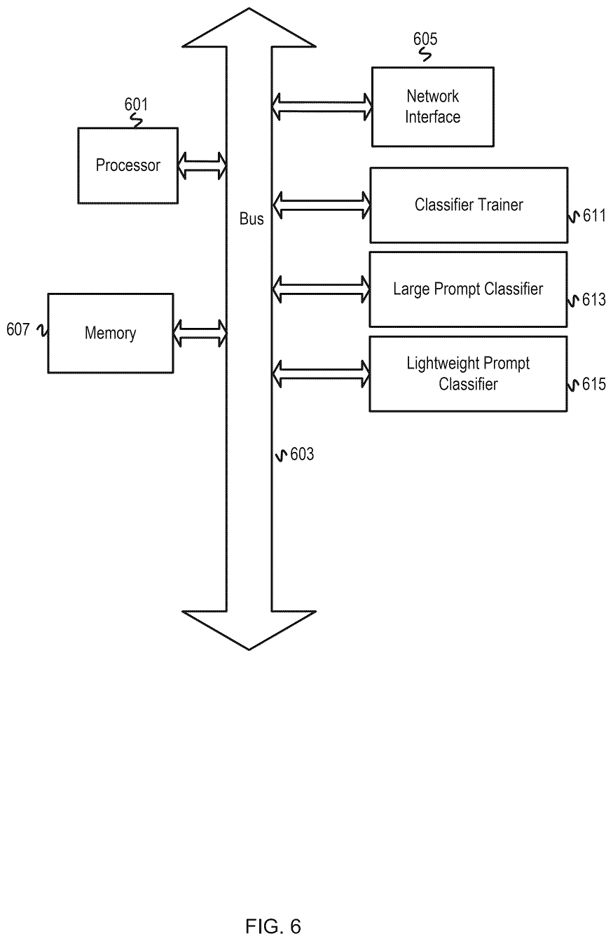

FIG. 6 depicts an example computer system with a classifier trainer, a large prompt classifier, and a lightweight prompt classifier. The computer system includes a processor 601 (possibly including multiple processors, multiple cores, multiple nodes, and/or implementing multi-threading, etc.). The computer system includes memory 607. The memory 607 may be system memory or any one or more of the above already described possible realizations of machine-readable media. The computer system also includes a bus 603 and a network interface 605. The system also includes a classifier trainer 611, a large prompt classifier 613, and a lightweight prompt classifier 615. The classifier trainer 611 trains the large prompt classifier 613 to classify prompts as malicious or benign using double cross-entropy loss. The classifier trainer 611 then trains the lightweight prompt classifier 615 to classify prompts as malicious or benign using a sum of cross-entropy loss and KD loss with outputs of the (now trained) large prompt classifier 613 and outputs of the lightweight prompt classifier 615. Once trained, the classifier trainer 611 deploys the large prompt classifier 613 or the lightweight prompt classifier 615 for prompt classification depending on operational constraints such as the volume of prompts to classify. The large prompt classifier 613 and lightweight prompt classifier 615 both comprise an NLP model with the same architecture (e.g., input layers, a tokenizer, vector embedding layers, and dynamic compression layers). The large prompt classifier 613 is a composition of the NLP model with a large (e.g., billions of parameters) neural network and the lightweight prompt classifier 615 is a composition of the NLP model with a small (e.g., thousands of parameters) neural network. Any one of the previously described functionalities may be partially (or entirely) implemented in hardware and/or on the processor 601. For example, the functionality may be implemented with an application-specific integrated circuit, in logic implemented in the processor 601, in a co-processor on a peripheral device or card, etc. Further, realizations may include fewer or additional components not illustrated in FIG. 6 (e.g., video cards, audio cards, additional network interfaces, peripheral devices, etc.). The processor 601 and the network interface 605 are coupled to the bus 603. Although illustrated as being coupled to the bus 603, the memory 607 may be coupled to the processor 601.

1. A method comprising:
training a first composition of a first language model and a first natural language processing model to output confidence values that documents are malicious or benign with a low rate of false positive verdicts obtained from the confidence values, wherein training the first composition comprises, for each first training iteration and corresponding training documents,
invoking the first composition on the training documents to obtain first confidence values that the training documents are malicious or benign; and
backpropagating first loss through the first language model and the first natural language processing model, wherein the first loss quantifies a difference between the first confidence values and ground-truth malicious or benign labels for the training documents, further wherein the first loss is evaluated with a loss function that promotes a low false positive rate for malicious document verdicts obtained based on outputs of the first language model.

2. The method of claim 1, wherein the loss function comprises a sum of a cross-entropy loss function and a loss function that penalizes different error types in classifications.

3. The method of claim 1, wherein the loss function comprises the double cross-entropy loss function.

4. The method of claim 1, wherein the first natural language processing model comprises one or more tokenization layers, one or more embedding layers, and one or more dynamic compression layers.

5. The method of claim 1, further comprising training a second composition of a second language model and a second natural language processing model, wherein training the second composition comprises, for each second training iteration and corresponding training documents,
invoking the second natural language processing model on the training documents to obtain vector embeddings of the training documents;
invoking the first language model and the second language model on the vector embeddings to obtain second confidence values and third confidence values, respectively, that the training documents are malicious or benign; and
backpropagating second loss through the second language model and the second natural language processing model, wherein the second loss comprises a sum of the loss function evaluated on the third confidence values and a knowledge distillation loss function that takes the second confidence values and the third confidence values as inputs.

6. The method of claim 5, wherein the second language model comprises a lightweight convolutional neural network.

7. The method of claim 1, wherein the training documents comprise known malicious or benign prompts to a generative artificial intelligence system.

8. The method of claim 1, wherein the first language model comprises a transformer neural network.

9. A non-transitory, machine-readable medium having program code stored thereon, the program code comprising instructions to:
train a first classifier to output probabilities that documents are malicious or benign with a low rate of false positive verdicts obtained from the probabilities, wherein the first classifier comprises a composition of a first natural language processing model and a first neural network, wherein instructions to train the first neural network comprise instructions to, for each first training iteration and corresponding training documents,
invoke the first classifier on the training documents to obtain first probabilities that the training documents are malicious or benign; and
backpropagate first loss through the first classifier, wherein the first loss quantifies a difference between the first probabilities and ground-truth malicious or benign labels for the training documents, further wherein the first loss is evaluated with a loss function that promotes a low false positive rate for malicious document verdicts obtained based on outputs of the first classifier.

10. The machine-readable medium of claim 9, wherein the loss function comprises a sum of a cross-entropy loss function and a loss function that penalizes different error types in classifications.

11. The machine-readable medium of claim 9, wherein the loss function comprises the double cross-entropy loss function.

12. The machine-readable medium of claim 9, wherein the first natural language processing model comprises one or more tokenization layers, one or more embedding layers, and one or more dynamic compression layers.

13. The machine-readable medium of claim 9, wherein the program code further comprises instructions to train a second classifier, wherein the second classifier comprises composition of a second natural language processing model and a second neural network, wherein the instructions to train the second classifier comprise instructions to, for each second training iteration and corresponding training documents,
invoke the first classifier and the second classifier on the documents to obtain second probabilities and third probabilities, respectively, that the training documents are malicious or benign; and
backpropagate second loss through the second classifier, wherein the second loss comprises a sum of the loss function evaluated on the third probabilities and a knowledge distillation loss function that takes the second probabilities and the third probabilities as inputs.

14. The machine-readable medium of claim 13, wherein the second classifier comprises a lightweight convolutional neural network.

15. The machine-readable medium of claim 9, wherein the training documents comprise known malicious or benign prompts to a generative artificial intelligence system.

16. The machine-readable medium of claim 9, wherein the first classifier comprises a transformer neural network.

17. The machine-readable medium of claim 9, wherein the instructions to backpropagate the first loss through the first classifier comprise instructions to backpropagate the first loss through the first neural network and one or more layers of the first natural language processing model.

18. An apparatus comprising:
a processor; and
a machine-readable medium having instructions stored thereon that are executable by the processor to cause the apparatus to,
train a first classifier to output scores that documents are malicious or benign with a low rate of false positive verdicts obtained from the scores, wherein the first classifier comprises a composition of a first natural language processing model and a first neural network, wherein the instructions to train the first neural network comprise instructions executable by the processor to cause the apparatus to, for each first training iteration and corresponding training documents,
invoke the first classifier on the training documents to obtain first scores that the training documents are malicious or benign; and
backpropagate first loss through the first classifier, wherein the first loss quantifies a difference between the first scores and ground-truth malicious or benign labels for the training documents, further wherein the first loss is evaluated with a loss function that promotes a low false positive rate for malicious document verdicts obtained based on outputs of the first classifier.

19. The apparatus of claim 18, wherein the loss function comprises a sum of a cross-entropy loss function and a loss function that penalizes different error types in classifications.

20. The apparatus of claim 18, wherein the loss function comprises the double cross-entropy loss function.
